(19) United States
(12) Patent Application Publication
(10) Pub. No.: US 2007/0075941 A1
(43) Pub. Date: Apr. 5, 2007

(54) Electrowetting display device

(75) Inventors: Guofu Zhou, Eindhoven (NL); Leendert Marinus Hage, Eindhoven (NL); Rogier Hendrikus Magdalena Cortie, Eindhoven (NL); Mark Thomas Johnson, Eindhoven (NL); Bokke Johannes Feenstra, Eindhoven (NL); Robert Andrew Hayes, Eindhoven (NL); Anthony Roy Franklin, East Grinstead (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., BA Eindhoven (NL)

(21) Appl. No.: 10/574,448

(22) PCT Filed: Oct. 1, 2004
(86) PCT No.: PCT/IB04/51943

§ 371 Date: Apr. 4, 2006

(30) Foreign Application Priority Data
Oct. 8, 2003 (EP) 03256349.6

(51) Int. Cl. G09G 3/34

(52) U.S. Cl. 345/84

(57) ABSTRACT

Several possibilities of driving devices (13,14,15) for optical switches, especially displays (1) based on the principle of electrowetting are given. This principle uses optical switches comprising a first fluid (5) and a second fluid (6) immiscible with each other within a space between a first transparent support plate (3) and a second support plate (4), the second fluid being electro˜conductive or polar.

The invention relates to a display device comprising picture elements (pixels) having at least one first fluid and a second fluid immiscible with each other above a first transparent support plate, the second fluid being electroconductive or polar.

In general the fluids are contained within a space between the first transparent support plate and a second support plate, bur this is not strictly necessary.

If the fluid is a (colored) oil and the second fluid is water (due to interfacial tensions) a two-layer system is provided which comprises a water layer and an oil layer. However, if a voltage is applied between the water and an electrode on the first support plate the oil layer moves aside or breaks up due to electrostatic forces. Since parts of the water now penetrate the oil layer the picture element becomes partly transparent.

Display devices based on this principle have been described in PCT-Application WO 03/00196 (PH-NL 02.0129).

Intermediate optical states or gray levels—the optical states between a first extreme state and a second extreme state said (e.g. fully black and fully white) can be achieved using intermediate DC-voltage levels between the voltage levels introducing said extreme states (e.g. zero and a maximum voltage level). However, in practice the resulting gray-scale stability or reproducibility is experimentally found to be very poor and unacceptable for most applications.

It is one of the objectives of the invention to provide a display having driving means, which give an acceptable gray-scale stability.

To this end a display device according to the invention has driving means for applying voltages to the electrodes associated with a range of electro-optical states of the picture element between and including a first extreme state and a second extreme state said driving means providing during selection of a picture element variable voltages to said picture element. The variable voltages may be alternating voltages having a mean value substantially equal to a voltage associated with an electro-optical state of the picture element to be set. The variable voltages may comprise a DC part and an AC part the maximum and minimum voltages of the alternating voltages having a root mean square average value substantially equal to a voltage associated with an electro-optical state of the picture element to be set.

In further embodiments said driving means provide preceding voltages to a picture element prior to said voltages associated with the electro-optical states. Said preceding voltages for instance comprise a set of alternating voltages having an average value substantially equal to zero or an average value substantially equal to a voltage associated with an electro-optical state of the picture element to be set.

The invention is based on the insight that the application of these preceding voltages improves the homogeneity of the switching behavior of the oil film, avoiding the local spreading of the oil film and reducing the probability of breaking the oil film.

In another embodiment the display device has driving means for applying voltages to the electrodes associated within a range of electro-optical states of the picture element between and including a first extreme state and a second extreme state said driving means providing prior to selection of a picture element a voltage to said picture element bringing the picture element into one of the extreme states.

These and other aspects of the invention will now be elucidated with reference to some non-restricting embodiments and the drawing in which

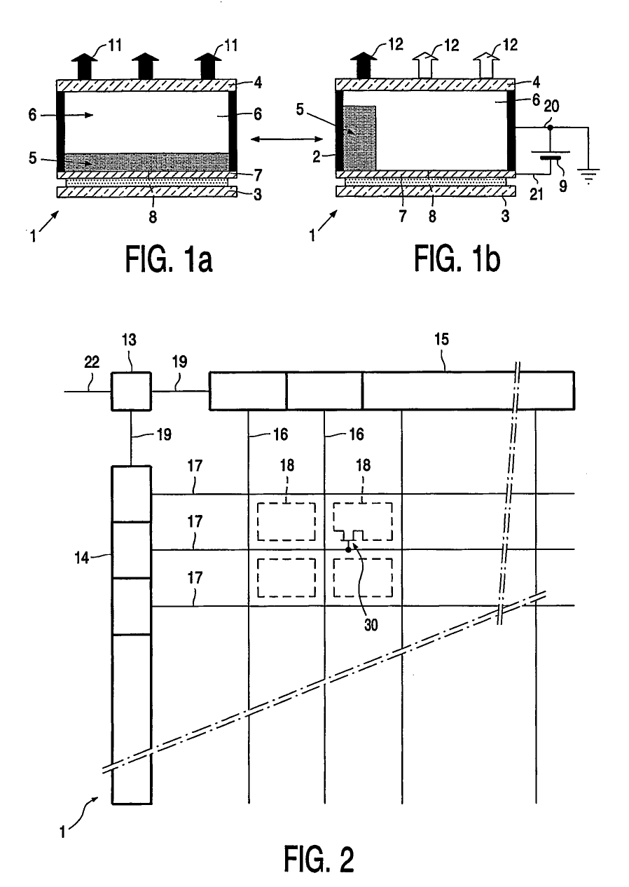

FIG. 1 shows diagrammatically cross-section of a part of a display device, in which the invention is used,

FIG. 2 schematically shows an electrical equivalent of a display device

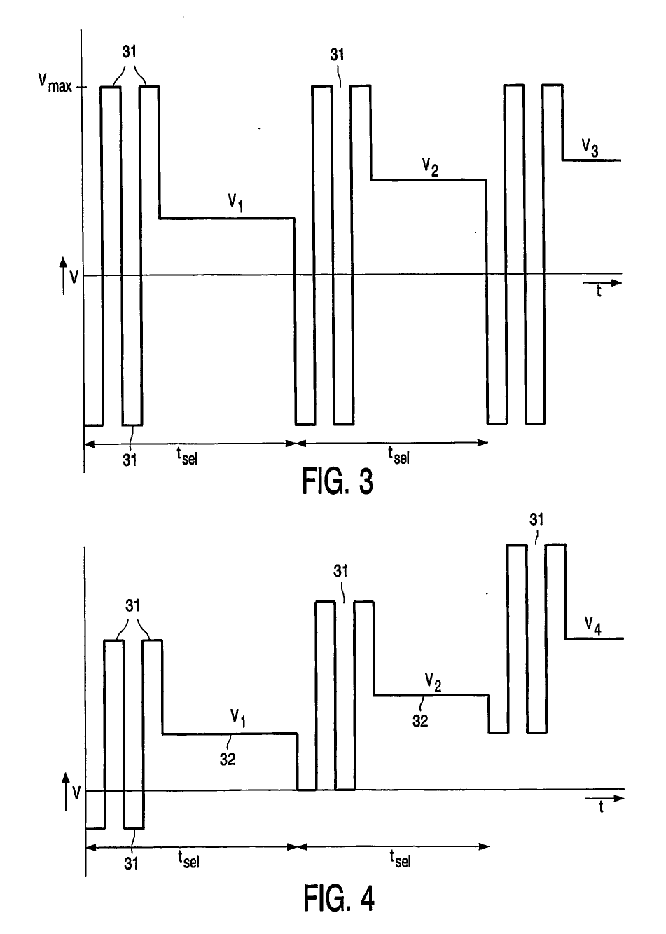

FIG. 3 schematically shows a way of driving picture elements in a device according to the invention,

FIG. 4 schematically shows another way of driving picture elements in a device according to the invention,

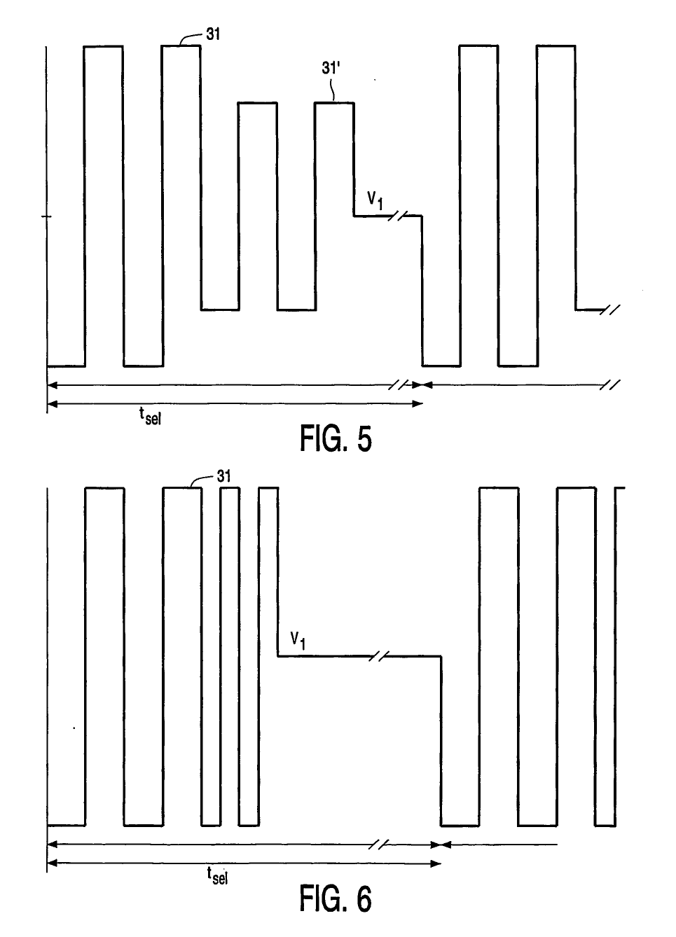

FIG. 5 schematically shows a way of driving picture elements in another device according to the invention,

FIG. 6 schematically shows another way of driving picture elements in a device according to the invention,

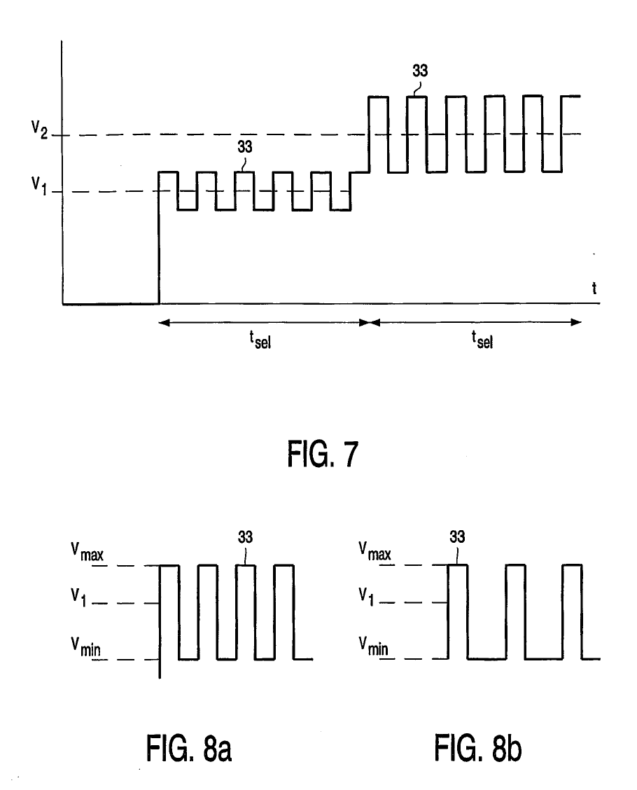

FIG. 7 schematically shows another way of driving picture elements in a device according to the invention,

FIG. 8 schematically shows modifications of FIG. 7, while

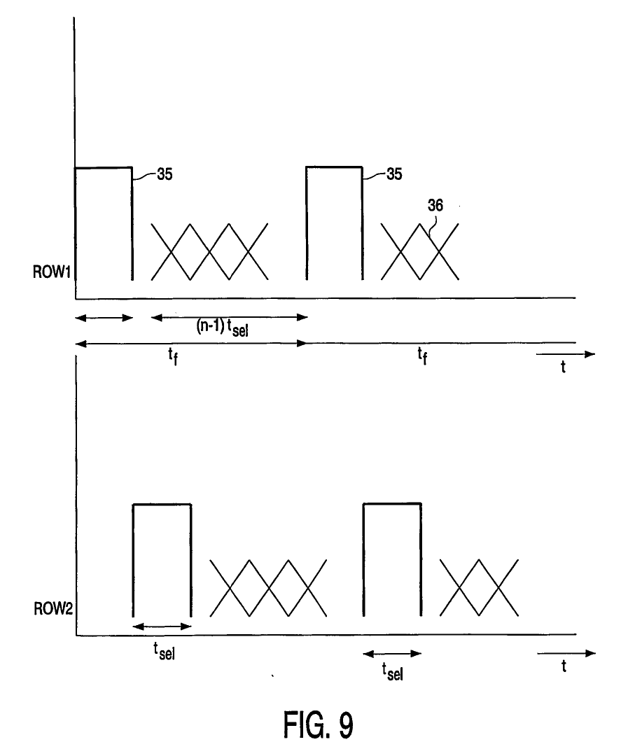

FIG. 9 schematically shows another way of driving picture elements in a device according to the invention using a reset method.

The Figures are diagrammatic and not drawn to scale. Corresponding elements are generally denoted by the same reference numerals.

FIG. 1 shows a diagrammatic cross-section of a part of a display device 1 which shows the principle on which a display device according to the invention is based. Between two transparent substrates or support plates 3, 4 a first fluid 5 and a second fluid 6 are provided, which are immiscible with each other. The first fluid 5 is for instance an alkane like hexadecane or as in this example a (silicone) oil. The second fluid 6 is electroconductive or polar, for instance water or a salt solution (e.g. a solution of KCl in a mixture of water and ethyl alcohol).

In a first state, when no external voltage is applied (FIG. 1a) the fluids 5, 6 adjoin the first and second transparent support plates 3, 4 of e.g. glass or plastic. On the first support plate 3 a transparent electrode 7, for example indium (tin) oxide is provided and an intermediate less wettable (hydrophobic) layer 8, in this example an amorphous fluoropolymer (AF 1600).

When a voltage is applied (voltage source 9) via interconnections 20, 21 the layer 5 moves aside or breaks up into small droplets (FIG. 1b). This occurs when the electrostatic energy gain is larger than the surface energy loss due to the creation of curved surfaces. As a very important aspect it was found that reversible switching between a continuous film 5 covering the support plate 3 and a film adjoining the wall 2 is achieved by means of the electrical switching means (voltage source 9).

FIG. 2 is an electric equivalent circuit diagram of a part of a display device 1 to which the invention is applicable. It comprises in one possible embodiment (one mode of driving, called the “passive mode”) a matrix of picture elements 18 at the areas of crossings of row or selection electrodes 17 and column or data electrodes 16. The row electrodes are consecutively selected by means of a row driver 14, while the column electrodes are provided with data via a data register 15. To this end, incoming data 22 are first processed, if necessary, in a processor 13.

Mutual synchronization between the row driver 14 and the data register 15 takes place via drive lines 19. The selection electrodes 17 and data electrodes 16 for example are connected to fluids 5, 6 via separate electrodes either directly as shown by means of electrodes 20, 21 in FIG. 1, or via a threshold elements such as a non—linear resistance or a non—linear switching element such as a MIM or a diode. A row of picture elements 18 may be driven by one or more selection electrodes 17; similarly a column of picture elements 18 may be driven by one or more data electrodes 16.

In another possible embodiment (another mode of driving, called the “active mode”) signals from the row driver 14 select the picture electrodes via thin-film transistors (TFTs) 30 whose gate electrodes are electrically connected to the row electrodes 17 and the source electrodes are electrically connected to the column electrodes. The signal, which is present at the column electrode 16, is transferred via the TFT to a picture electrode of a picture element 18 coupled to the drain electrode. The other picture electrodes are connected to, for example, one (or more) common counter electrode(s). In FIG. 2 only one thin film transistor (TFT) 30 has been drawn, simply as an example. Other “active mode” configurations are alternatively possible. Again one or more selection electrodes 17 may drive a row of TFTs 30, while one or more data electrodes 16.

FIG. 3 shows a first pulse pattern scheme with four pre-pulses (alternating voltages) 31 prior to a fixed voltage 32 (within a selection period tₛₑₗ) for the display. The value of the fixed voltage 32 (V₁, V₂, V₃) determines the gray value. The pulse length of the pre-pulses is not limited but preferably an order of magnitude shorter than the minimum time period required for driving the display from full black to full white state. It is preferred to use the maximum voltage level Vₘₐₓ which may be available e.g. at a driver IC as the amplitude of these pre-pulses 31. The number of these ac pre-pulses for a grayscale transition may be chosen arbitrarily but an even number is preferred and the total time period of these ac pulses in a grayscale transition is preferably less than 50% of the selection period tₛₑₗ. It appears that the accuracy and stability of the gray levels are improved after using a series of short ac-pulses prior to the gray level driving pulse before each transition. In this example, four short pulses—two negative and two positive pulses are used, the average DC voltage being equal to zero.

A further pulse pattern is schematically shown in FIG. 4, in which a series of short pre-pulses 31 is provided prior to the grayscale driving voltage pulse 32 for each transition. In this example, four short pulses—two negative and two positive pulses are used, the average DC voltage being equal to the gray level voltage (V₁, V₂, V₄). It appears that the pre-pulses are extremely powerful for improving the grayscale reproducibility in electrowetting displays. The pre-pulses however produce an optical response, which may become visible in particular when longer pre-pulses are used. To reduce this optical disturbance induced by the pre-pulses the pre-pulses preferably are applied with different polarity to different parts of the screen

In the following frame, positive and negative polarities are inverted. The perceptual appearance of the display will be hardly be effected, since the eye averages these short range brightness variations over subsequent frames.

Another possible pulse pattern is schematically shown in FIG. 5 in which the pre-pulses 31 have a certain amplitude at the beginning and smaller amplitude (pre-pulses 31′) at the end of the pre-pulse sequence. The voltage sweeps between negative and positive voltage decrease, resulting in lower power consumption (especially at a larger number of pre-pulses)

A fourth embodiment is illustrated in FIG. 6, in which the ac pulses have a decreased pulse time periods and constant amplitude. The advantage of this embodiment is shortening of the total image update time. In a combined (not shown) embodiment the pre-pulses have both variable amplitude and variable pulse time periods. This gives additional flexibility for an optimal combination leading to minimum image update time, power consumption, lower optical flickers and optimal performance.

It has further been found that improved grayscale reproducibility and relatively short image update time are obtained by modifying the grayscale driving voltage pulse 32 into a series of short voltage pulses 33 (FIG. 7) with alternating amplitude the mean voltage being equal or close to the DC voltage level (V₁, V₂) that is required for driving the display to the desired gray level. Although not shown, the short voltage pulses 33 may be preceded by pre-pulses, similar to those in the embodiments of FIGS. 3-6.

FIG. 8^{a} shows a modification in which a series of such short voltage pulses 33 with a RMS (root mean square) average voltage √[(Vₘₐₓ²+Vₘᵢₙ²)/2] approximately equal to the DC voltage level that is required for driving the display to the desired gray level (V₁) as does FIG. 8^{b}, in which a series of short voltage pulses has asymmetric time periods with a RMS average voltage, which is again approximately equal to the DC voltage level that is required for driving the display to the desired gray level.

FIG. 9 shows a way of driving the display by using a reset pulse 35 bringing the picture element into one of the extreme states (either fully on or fully off) before applying the grayscale driving pulses 36 for a grayscale transition. The length of this reset pulse is not limited but preferably as short as possible, e.g. less than 50% of the total addressing time, depending on the application and the properties of the display element. Since the response time and consequently resetting depends on the previous gray value, the reset pulse should have a reset voltage and a pulse width (total pulse energy) to reset all possible gray values to the initial state.

If the properties (especially response time) of the display element are such that a longer reset time is needed, in matrix driving the reset pulse may be given during a selection time of a row of display elements (line), which is a certain period ahead of the selection time for presenting information to the same row of display elements (it may even be applied in an earlier frame time).

The invention is not restricted to the examples mentioned above. If a difference in switching on and switching off speed exists, the RMS requirement of FIGS. 7, 8 may not give the correct gray-value. The average voltage level among these short pulses should then be selected so that the resulting reflection vs time curve fits to the gray-scale driving voltage vs time curve. The gray-levels will then not drift away by and image quality is significantly improved whist the image update time remains short. The use of the asymmetric pulses allows one to finely tune the pulses in order to achieve accurate gray—scales.

Part of the display may be driven in another drive mode than another part and within a certain mode, frequencies may differ for different parts of the display as may voltage values and polarities of preceding voltages.

Although a display device between two transparent substrates has been shown the support plate 7 comprising the electrodes 7 and the oil layer 5 (FIG. 1a) may even be immersed in an open water container.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A display device having at least one picture element (18) having an optical switch comprising at least one first fluid (5) and a second fluid (6) immiscible with each other above a first support plate (3), the second fluid being electro-conductive or polar which display device has driving means (13, 14, 15) for applying to electrodes (7, 20, 21) of the optical switch voltages associated with a range of electro-optical states of the picture element between and including a first extreme state and a second extreme state said driving means providing during selection of a picture element variable voltages to said picture element.

2. A display device according to claim 1 comprising the fluids within a space between a first transparent support plate (3) and a second support plate (4).

3. A display device according to claim 1 in which the variable voltages comprise a set of alternating voltages (33) having a mean value substantially equal to a voltage (Vᵢ) associated with an electro-optical state of the picture element to be set.

4. A display device according to claim 3 in which the variable voltages comprise a DC part and an AC part the maximum and minimum voltages of the alternating voltages having a having a root mean square average value substantially equal to a voltage associated with an electro-optical state of the picture element to be set.

5. A display device according to claim 4 comprising different time periods for parts of the variable voltage curves having voltage values above said root mean square average value and parts of the variable voltage curves having voltage values below said root mean square average value.

6. A display device according to claim 1 said driving means providing preceding voltages (35) to a picture element prior to said voltages associated with the electro-optical states.

7. A display device according to claim 6 in which the preceding voltages comprise a set of alternating voltages having an average value substantially equal to zero.

8. A display device according to claim 6 in which the preceding voltages comprise a set of alternating voltages having an average value substantially equal to a voltage associated with an electro-optical state of the picture element to be set.

9. A display device according to claim 7 in which in driving at least one picture element the amplitude of the preceding voltages decreases.

10. A display device according to claim 7 in which in driving at least one picture element the frequency of the preceding voltages increases.

11. A display device according to claim 7 in which the preceding voltages have different values for different parts of the display.

12. A display device according to claim 7 in which the preceding voltages have different polarities for different parts of the display.

13. A display device according to claim 6 in which the preceding voltages comprise a voltage to said picture element bringing the picture element into one of the extreme states.

14. A display device according to claim 1 said driving means providing after at least one selection period of a picture element driving voltages of opposite polarity to said picture element.

15. A display device having at least one picture element having an optical switch comprising at least one first fluid and a second fluid immiscible with each other within a space on a first transparent support plate, the second fluid being electro-conductive or polar which display device has driving means for applying voltages to the electrodes associated within a range of electro-optical states of the picture element between and including a first extreme state and a second extreme state said driving means providing prior to selection of a picture element a voltage to said picture element bringing the picture element into one of the extreme states.

16. A display device according to claim 15 comprising the fluids within a space between a first transparent support plate (3) and a second support plate (4).

17. A display device according to claim 15 said driving means providing the voltages associated with a range of electro-optical states after at least one selection period after bringing the picture element into one of the extreme states.
